(19) United States
(12) Patent Application Publication
(10) Pub. No.: US 2023/0139656 A1
(43) Pub. Date: May 4, 2023

(54) METHOD AND SYSTEM OF MACHINE LEARNING MODEL VALIDATION IN BLOCKCHAIN THROUGH ZERO KNOWLEDGE PROTOCOL

(71) Applicant: MASTERCARD INTERNATIONAL INCORPORATED, Purchase, NY (US)

(72) Inventors: Vikas BISHNOI, Jodhpur (IN); Mridul SAYANA, Mumbai (IN); Gaurav DHAMA, Gurgaon (IN); Nidhi MULAY, Indore (IN)

(73) Assignee: MASTERCARD INTERNATIONAL INCORPORATED, Purchase, NY (US)

(21) Appl. No.: 17/518,023

(22) Filed: Nov. 3, 2021

(51) Int. Cl. G06F 11/34; G06F 11/30; H04L 9/32

(52) U.S. Cl. CPC G06F 11/3457; G06F 11/302; H04L 9/3218; H04L 9/3236; H04L 2209/38

(57) ABSTRACT

A method for determining the validity of a computational model using a blockchain and zero knowledge principles includes: storing, in a memory of a first computing system, a computational model; receiving, by a receiver of the first computing system, a blockchain data value from one block of a plurality of blocks comprising a blockchain, wherein the blockchain data value includes a data set; receiving, by the receiver of the first computing system, an expected accuracy value; applying, by a processor of the first computing system, the data set to the computational model to generate a result value; and determining, by the processor of the first computing system, a validity measurement for the computational model based on a comparison of the generated result value and the expected accuracy value.

### FIELD

The present disclosure relates to determining the validity of a computational model using blockchain and zero knowledge protocols, specifically the use of a blockchain for conveying a synthetic data set that can be applied to a computational model for validation thereof without transmission of the model itself or any real data sets following zero knowledge principles.

### BACKGROUND

As the availability of computing power has increased, the use of artificial intelligence and machine learning has also increased. Machine learning has been applied across a variety of industries and applications ranging from simple to exceedingly complex, such as for photo processing, facial recognition, weather modeling, video game design, self-driving vehicles, fraud detection, etc. In these types of applications, data can be applied to a model that utilizes machine learning, or another type of computational model, and receive valuable data, insights, estimates, predictions, etc. For instance, a self-driving vehicle may be able to navigate a new area successfully using navigational data, or a financial institution may be able to identify fraudulent transactions using insights regarding spending behavior.

However, machine learning and other computational models can often be extremely difficult from both a time and resource standpoint to develop. As a result, there are entities dedicated to developing models for use by others, where an entity in need of such a model may purchase the model or a right to use the model from the developer. However, an entity may want to be assured of the accuracy of a model or the validity of a model that is available or may have some other need for testing a computational model, such as to be sure a version of the model they have is accurate or genuine in cases of the model being obtained via a third party. In such instances, the developer may be apprehensive about making their model or any details of the model available. At the same time, the entity hoping to use the model may not want to provide, or may be prohibited from providing, its sensitive data to the developer that it wants to use in the model, possibly due to laws or regulations.

Thus, there is a need for a technological solution that can enable the developer of a computational model and a second party interested in using the computational model to communicate data and variables necessary for the second party to validate the accuracy and genuineness of the computational model, but without sharing real data sets or details regarding the model itself, i.e., through a zero knowledge protocol.

### SUMMARY

The present disclosure provides a description of systems and methods for determining the validity of a computational model using a blockchain and zero knowledge principles. The developer of the computational model can generate a synthetic data set that approximates a real data set that may be used by the entity hoping to validate the model. The developer posts the data set to a blockchain, where the data set is immutable and can be independently verified by the validating entity, which also ensures that the validating entity will use the correct data set. The developer also makes their own expected result of applying the synthetic data set to the computational model to be used by the validating entity available, through the blockchain or another channel. The validating entity can retrieve the synthetic data set and apply it to their copy of the computational model. The validating entity then determines the validity of their computational model by comparing their own result with the expected result made available by the developer. The result is that the validating entity can be assured of the accuracy and validity of their copy of the computational model without the validating entity or developer providing any real data or any information at all regarding the computational model itself. This type of exchange using zero knowledge principles therefore protects all entities involved, even when a blockchain, as a public or permissioned data source, is used, thus enabling any number of interested parties to validate the computational model while still protecting the model and all entities involved.

A method for determining the validity of a computational model using a blockchain and zero knowledge principles includes: storing, in a memory of a first computing system, a computational model; receiving, by a receiver of the first computing system, a blockchain data value from one block of a plurality of blocks comprising a blockchain, wherein the blockchain data value includes a data set; receiving, by the receiver of the first computing system, an expected accuracy value; applying, by a processor of the first computing system, the data set to the computational model to generate a result value; and determining, by the processor of the first computing system, a validity measurement for the computational model based on a comparison of the generated result value and the expected accuracy value.

A system for determining the validity of a computational model using a blockchain and zero knowledge principles includes a first computing system including: a memory storing a computational model; a receiver receiving a blockchain data value from one block of a plurality of blocks comprising a blockchain, wherein the blockchain data value includes a data set, and an expected accuracy value; and a processor applying the data set to the computational model to generate a result value, and determining a validity measurement for the computational model based on a comparison of the generated result value and the expected accuracy value.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for determining validity of a computational model in accordance with exemplary embodiments.

FIG. 2 is a block diagram illustrating a computing system of the system of FIG. 1 for use in determining the validity of a computational model in e-commerce transactions in accordance with exemplary embodiments.

FIG. 3 is a flow diagram illustrating a process for determining validity of a computational model in the system of FIG. 1 in accordance with exemplary embodiments.

FIG. 4 is a flow chart illustrating an exemplary method for determining validity of a computational model using a blockchain and zero knowledge principles in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency, but other digital data including, e.g., provenance, medical, birth, property or other records to name only a few possibilities.

### System for Determining Validity of a Computational Model

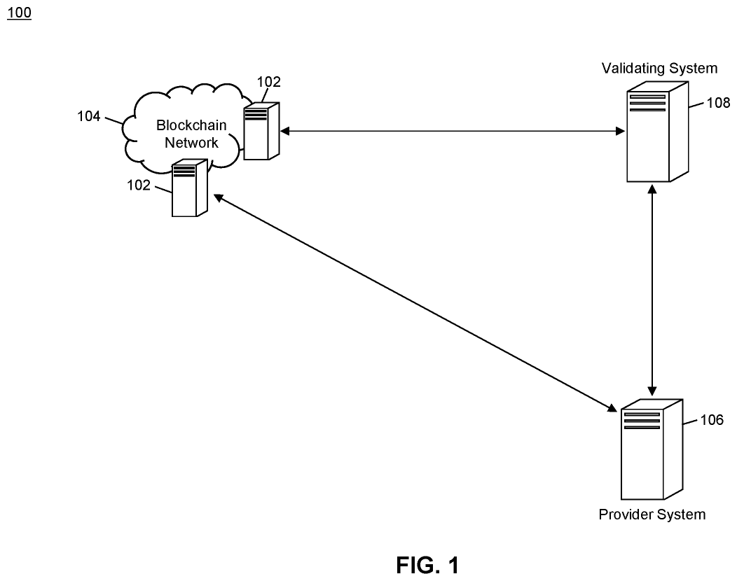

FIG. 1 illustrates a system 100 for determining the validity of a computational model using a combination of blockchain and zero knowledge principles.

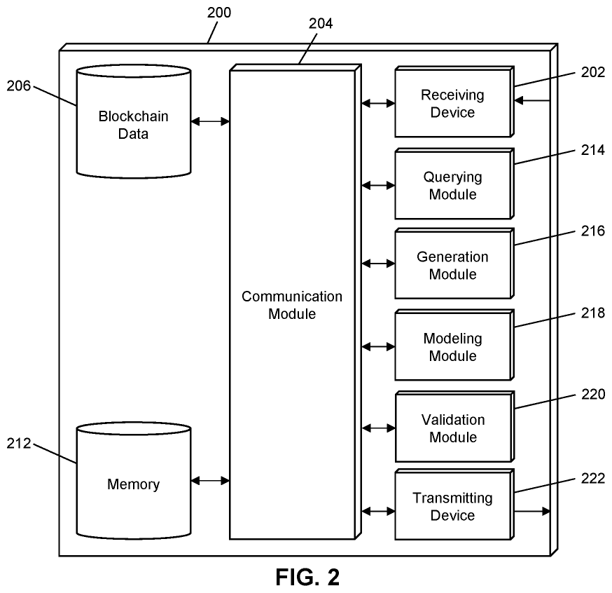

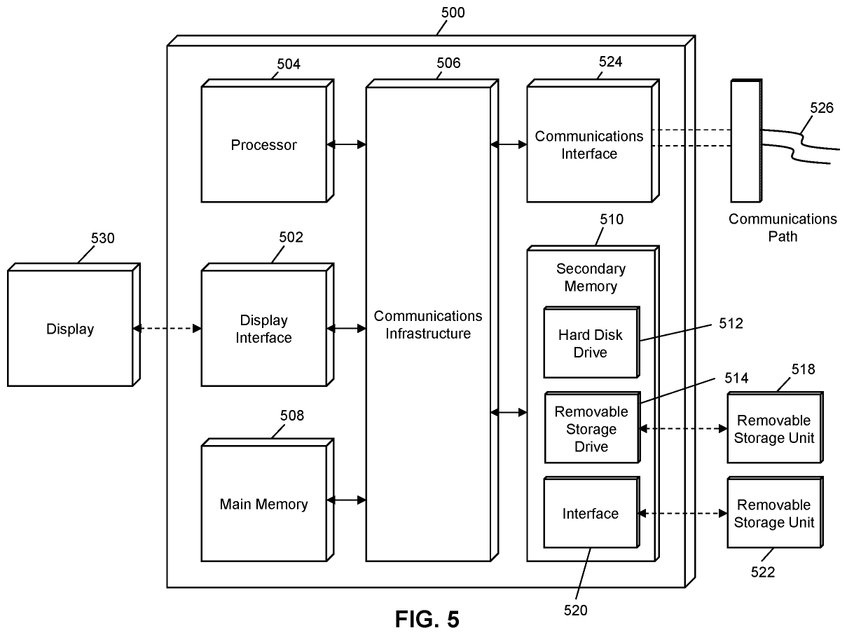

The system 100 may include one or more blockchain nodes 102. Each blockchain node 102 may be part of a blockchain network 104. Each blockchain node 102 may be a computing system, such as illustrated in FIGS. 2 and 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 102 in the blockchain network 104 prior to the generation and addition of a new block to the blockchain in order for the change to be made permanent. Computational and communication limitations may make such a modification exceedingly difficult, if not impossible, thus rendering the blockchain immutable.

In some embodiments, the blockchain may be used to store information regarding blockchain transactions conducted between two different blockchain wallets. A blockchain wallet may include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” may refer specifically to the private key. In other cases, the term “blockchain wallet” may refer to a computing device that stores the private key for use thereof in blockchain transactions. For instance, each computing device may each have their own private key for respective cryptographic key pairs and may each be a blockchain wallet for use in transactions with the blockchain associated with the blockchain network. Computing devices may be any type of device suitable to store and utilize a blockchain wallet, such as a desktop computer, laptop computer, notebook computer, tablet computer, cellular phone, smart phone, smart watch, smart television, wearable computing device, implantable computing device, etc.

In the system 100, the blockchain may be used to store synthetic data sets and other data used in the validation of a computational model. The system 100 may include a provider system 106. The provider system 106 may be a computing system of any suitable type that is operated by or otherwise associated with an entity that develops or otherwise provides a computational model for use or validation by other entities. The provider system 106 may be an entity that develops computational model for use in facial recognition to name but one of many possibilities, where an interested party may obtain the computational model and supply image data to the model, where the model may output details regarding faces, facial structures, etc. detected in the supplied image data.

The system 100, a validating system 108 may be interested in the computational model and submit a request to the provider system 106 for a synthetic data set to use in validating the computational model. The request may include an identifier associated with the computational model for use by the provider system 106 in identifying the computational model the validating system 108 wants to validate, such as in cases where the provider system 106 may develop multiple computational models or where a single computational model may have multiple versions. The provider system 106 may identify the correct computational model and/or version and may then generate a synthetic data set for applying to the computational model.

The synthetic data set may be generated by the provider system 106 using any suitable method, where the synthetic data set approximates real data that may be applied to the computational model (e.g., by the validating system 108 in use of the computational model), but without using real data. For instance, the synthetic data set may include drawn or otherwise fabricated facial features and faces, in one example. By not using any real data in the validity test, the validating system 108 can still successfully validate the computational model without having to provide any real data to the provider system 106, which may facilitate compliance with applicable laws and regulations. The synthetic data set may be generated using random number generators, pseudo-random generators, or other techniques used in the generation of synthetic data that approximates real data. For instance, in one example, the provider system 106 may use a known or new generative adversarial network (GAN). In such an example, the provider system 106 may use known data sets, which may be provided by the validating system 108 (e.g., older or obsolete data sets or other data the validating system 108 may be authorized to provider) or another entity or already known to the provider system 106, such as used in the development of the computational model, as initial training data for a discriminator, where the discriminator and generator operate to develop the synthetic data set.

Once the synthetic data set has been generated by the provider system 106, the provider system 106 may apply the synthetic data set to the identified computational model. The result of the application may be registered by the provider system 106 and made available to the validating system 108 as an expected result to test the accuracy of their copy of the model. In some cases, the provider system 106 may respond to the validating system's request for the synthetic data set with the expected result value using any suitable communication network and method. In other cases, the provider system 106 may include the expected result value with the synthetic data set, as discussed below.

The provider system 106 may electronically transmit the synthetic data set to a blockchain node 102 in the blockchain network 104 using a suitable communication network and method. The blockchain node 102 may generate a new block where the synthetic data set may be included in the new block as part of or comprising a blockchain data value. In some embodiments, the blockchain data value that includes the synthetic data set may also include the identifier for the computational model, such as was included in the request submitted to the provider system 106 by the validating system 108. In some cases, the blockchain data value may also include the expected result generated by the provider system 106 by applying the synthetic data set to the computational model. The new block with the blockchain data value including the synthetic data set may be distributed to other blockchain nodes 102 in the blockchain network 104, confirmed, and then added to the blockchain. In some embodiments, the provider system 106 may operate as a blockchain node 102 in the blockchain network 104.

Once the synthetic data set has been added to the blockchain, the validating system 108 may retrieve the synthetic data set therefrom. In some cases, the validating system 108 may monitor the blockchain (e.g., via a blockchain node 102) and identify a new blockchain data value that includes the identifier submitted in the request to the provider system 106 to identify the correct synthetic data set to use. In other cases, the provider system 106 may provide the validating system 108 with information to be used in identifying the synthetic data set, such as in response to the request initially submitted by the validating system 108. For example, the blockchain data value may also include an identifier that is unique to the blockchain data value among all blockchain data values in all blocks in the blockchain, which may be returned to the provider system 106 by the blockchain node 102 or identified by the provider system 106 in the blockchain data value (e.g., identified using its known synthetic data set). The provider system 106 may include this identifier in a response to the request submitted by the validating system 108 (e.g., which may also include the expected result value), which the validating system 108 may then use to identify the correct blockchain data value and obtain the synthetic data set therefrom.

Once the validating system 108 has obtained the synthetic data set, the validating system 108 may apply the synthetic data set to its copy of the computational model. The validating system 108 may generate a result via the application of the synthetic data set to the computational model. For example, if the computational model is used for facial recognition, the validating system 108 may supply synthetic image data to the computational model, where the result may be facial identification or data regarding detected facial features. The validating system 108 may then compare the result it obtained via its own application to the expected result value received from the provider system 106. If the results match or are within an acceptable tolerance level (e.g., set by the provider system 106 for the computational model and/or by the validating system 108 for its own benefit or requirements such as a threshold for the number of incorrect result events), then the validating system 108 may consider its copy of the computational model to be validated. In some cases, the validating system 108 may also use the application of the synthetic data set to test the accuracy or quality of the computational model, such as to ensure the computational model will be suitable for the intended use by the validating system 108. If the result of the validating system's own application of the synthetic data set to its copy of the computational model does not match, or is not within the acceptable tolerance level of, the provider system's expected result value, then the validating system 108 may determine that its copy of the computational model is not valid. The validating system 108 may then communicate with the provider system 106 to resolve the issue, such as by obtaining a new copy of the computational model, performing another test, modifying its computational model, etc.

In some embodiments, the provider system 106 may provide additional variables to the validating system 108 for further use in validating the computational model. Additional variables may be any additional data regarding the computational model, synthetic data set, and/or the provider system 106. For instance, the provider system 106 may provide version data, time data (e.g., time and/or date of creation of the computational model and/or synthetic data set), parameters for application of the synthetic data set, weighting data, modifications for the computational model, identifiers for the provider system 106, cryptographic keys, digital signatures, etc. The additional variables may be made available to the validating system 108 before the test (e.g., in response to the request submitted by the validating system 108, in a separate communication, in the blockchain data value used to store the synthetic data set, etc.), or may be made available after the test. For instance, the validating system 108 may determine that its copy of the computational model is valid but may request additional variables to determine if the provider system 106 is genuine (e.g., to authenticate the provider system 106 to prevent a fraudulent entity from posing as the provider system 106).

In some embodiments, the synthetic data set may be subject to one or more limitations in its use. For instance, in one example, the synthetic data set may have an expiration date. In some cases, the expiration date may be publicly known, such as included in the blockchain data value used to store the synthetic data set. In other cases, the expiration date may be known to the validating system 108, such as provided with the expected result value in the response to the request submitted by the validating system 108. In yet other cases, the expiration date may only be known by the provider system 106. The expiration date may serve as a limit on when the synthetic data set may be used in the computational model to obtain the expected result value provided by the provider system 106. For example, the computational model may provide a different result after the expiration date or may be configured to not accept the synthetic data set after the expiration date, such as to prevent the use of old data, prevent applicability to outdated computational models, ensure that new requests are submitted when a computational model is tested, etc. Other limitations on use may include a number of overall uses of a synthetic data set, limit on the number of or identity of entities authorized to use the synthetic data set, limit on which computational models the synthetic data set may be applied to, etc.

In some embodiments, the provider system 106 may provide for the ability of a validating system 108 to ensure validity of a synthetic data set and/or authentication of the provider system 106 prior to applying the synthetic data set to its computational model. For instance, in one example, the provider system 106 may digitally sign the synthetic data set using a private key of a cryptographic key pair, where the digital signature may be included in the blockchain data value that stores the synthetic data set. The provider system 106 may provide the corresponding public key of the cryptographic key pair to the validating system 108, such as in response to the initial request submitted by the validating system 108. The validating system 108 may then use the public key to validate the digital signature. In another example, the provider system 106 may encrypt the synthetic data set using a public key of a cryptographic key pair and may provide the corresponding private key to the validating system 108, which may use the private key to decrypt the synthetic data set.

The methods and systems discussed herein enable a computational model to be validated by a validating system 108. By using a blockchain, a synthetic data set can be shared in a public platform in a manner that is immutable, ensuring that the data set is not tampered with and cannot be modified by the provider system 106 once submitted. By using a synthetic data set, all real data is protected and not transmitted across any communication networks while still enabling the validating system 108 to test the accuracy and capabilities of the computational model. The methods and systems discussed herein utilize zero knowledge principles to enable the validating system 108 to validate the computational model without any exchange of real data or any data of the computational model itself, thus protecting the validating system 108, the provider system 106, and the computational model. As a result, the methods and systems discussed herein provide for significant technological improvements over existing methods for determining validity of a computational model.

### Computing System

FIG. 2 illustrates an embodiment of a computing system 200, such as may be used as the blockchain node 102, provider system 106, or validating system 108 in the system 100. It will be apparent to persons having skill in the relevant art that the embodiment of the computing system 200 illustrated in FIG. 2 is provided as illustration only and may not be exhaustive to all possible configurations of the computing system 200 suitable for performing the functions as discussed herein. For example, the computer system 500 illustrated in FIG. 5 and discussed in more detail below may be a suitable configuration of the computing system 200.

The computing system 200 may include a receiving device 202. The receiving device 202 may be configured to receive data over one or more networks via one or more network protocols. In some instances, the receiving device 202 may be configured to receive data from blockchain nodes 102, provider systems 106, validating systems 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by blockchain nodes 102, which may be superimposed or otherwise encoded with blockchain data values, data value identifiers, blocks, blockchain data, confirmation messages, etc. The receiving device 202 may be configured to receive data signals electronically transmitted by provider systems 106 that may be superimposed or otherwise encoded with synthetic data sets, blockchain data values, cryptographic keys, computing model identifiers, expected result values, additional variables, etc. The receiving device 202 may be configured to receive data signals electronically transmitted by validating systems 108, which may be superimposed or otherwise encoded with requests for computational model validity tests, requests for blockchain data values, requests for additional variables, computational model test results, etc.

The computing system 200 may also include a communication module 204. The communication module 204 may be configured to transmit data between modules, engines, databases, memories, and other components of the computing system 200 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing system 200 and external components of the computing system 200, such as externally connected databases, display devices, input devices, etc. The computing system 200 may also include a processing device. The processing device may be configured to perform the functions of the computing system 200 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, modeling module 218, validation module 220, etc. As used herein, the term “module” may be software executed on hardware or hardware particularly programmed or configured to receive an input, perform one or more processes using the input, and provides an output. The input, output, and processes performed by various modules will be apparent to one skilled in the art based upon the present disclosure.

The computing system 200 may also include blockchain data 206, which may be stored in a memory 212 of the computing system 200 or stored in a separate area within the computing system 200 or accessible thereby. The blockchain data 206 may include a blockchain, which may be comprised of a plurality of blocks and be associated with the blockchain network 104. The blockchain data 206 may also or alternatively include any data associated with one or more blockchain wallets that may be used by the computing system 200, such as cryptographic key pairs, unspent transaction outputs, digital asset amounts, network identifiers for the blockchain network 104, smart contracts, signature generation algorithms, encryption algorithms, transaction account data, account balances, communication information for third party services, etc.

The computing system 200 may also include a memory 212. The memory 212 may be configured to store data for use by the computing system 200 in performing the functions discussed herein, such as public and private keys, symmetric keys, etc. The memory 212 may be configured to store data using suitable data formatting methods and schema and may be any suitable type of memory, such as read-only memory, random access memory, etc. The memory 212 may include, for example, encryption keys and algorithms, communication protocols and standards, data formatting standards and protocols, program code for modules and application programs of the processing device, and other data that may be suitable for use by the computing system 200 in the performance of the functions disclosed herein as will be apparent to persons having skill in the relevant art. In some embodiments, the memory 212 may be comprised of or may otherwise include a relational database that utilizes structured query language for the storage, identification, modifying, updating, accessing, etc. of structured data sets stored therein. The memory 212 may be configured to store, for example, cryptographic keys, salts, nonces, communication information for other computing systems, mapping information, generation algorithms, modeling algorithms, computational models, neural networks, models for generation of synthetic data sets, etc.

The computing system 200 may include a querying module 214. The querying module 214 may be configured to execute queries on databases to identify information. The querying module 214 may receive one or more data values or query strings and may execute a query string based thereon on an indicated database, such as the memory 212 of the computing system 200 to identify information stored therein. The querying module 214 may then output the identified information to an appropriate engine or module of the computing system 200 as necessary. The querying module 214 may, for example, execute a query on the memory 212 to identify a computational model using a received identifier and then to identify data to be applied to a generative adversarial network to generate a synthetic data set for the identified computational model.

The computing system 200 may also include a generation module 216. The generation module 216 may be configured to generate data for use by the computing system 200 in performing the functions discussed herein. The generation module 216 may receive instructions as input, may generate data based on the instructions, and may output the generated data to one or more modules of the computing system 200. For example, the generation module 216 may be configured to generate synthetic data sets, generate computational models, generate cryptographic key pairs, generate digital signatures, etc.

The computing system 200 may also include a modeling module 218. The modeling module 218 may be configured to perform functions related to computational models for the computing system 200. The modeling module 218 may receive instructions as input, may perform one or more functions as part of execution of the received instructions, and may output data as a result to another module or engine of the computing system 200. In some cases, the modeling module 218 may also receive a computational model or data set to be used in executing received instructions. In other cases, the modeling module 218 may be configured to identify such data (e.g., via instructing the querying module 214) in order to execute its supplied instructions. The modeling module 218 may be configured to, for example, apply data sets to a computational model and generate result values.

The computing system 200 may also include a validation module 220. The validation module 220 may be configured to perform validations for the computing system 200 as part of the functions discussed herein. The validation module 220 may receive instructions as input, which may also include data to be used in performing a validation, may perform a validation as requested, and may output a result of the validation to another module or engine of the computing system 200. The validation module 220 may, for example, be configured to validate digital signatures using suitable signature generation algorithms and keys, validate computational models, validate additional variables, etc.

The computing system 200 may also include a transmitting device 222. The transmitting device 222 may be configured to transmit data over one or more networks via one or more network protocols. In some instances, the transmitting device 222 may be configured to transmit data to blockchain nodes 102, provider systems 106, validating systems 108, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to blockchain nodes 102, which may be superimposed or otherwise encoded with blockchain data values, data value identifiers, blocks, blockchain data, confirmation messages, requests for blockchain data values, synthetic data sets, etc. The transmitting device 222 may also be configured to electronically transmit data signals to provider systems 106, which may be superimposed or otherwise encoded with requests for computational model validity tests, computational model test results, blockchain data value identifiers, etc. The transmitting device 222 may be configured to electronically transmit data signals to validating systems 108 that may be superimposed or otherwise encoded with blockchain data value identifiers, cryptographic keys, additional variables, expected result values, etc.

### Process for Determining Validity of a Computational Model

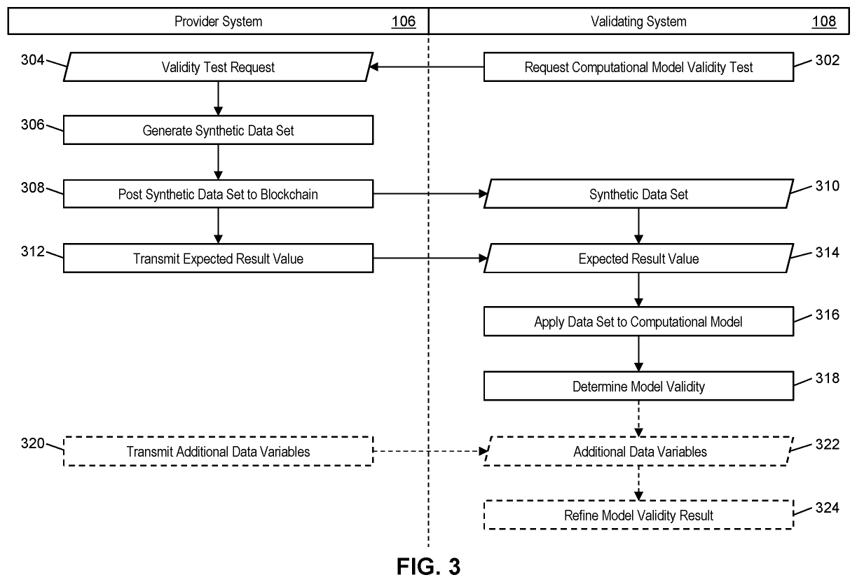

FIG. 3 illustrates a process for determining the validity of a computational model in the system 100 that utilizes zero knowledge principles using a blockchain and a synthetic data set.

In step 302, the validating system 108 may electronically transmit (e.g., via a transmitting device 222) a request for a computational model validity test to the provider system 106 using a suitable communication network and method. The request may include at least an identifier associated with the computational model that the validating system 108 is interested in testing the validity of. In step 304, the provider system 106 may receive (e.g., via a receiving device 202) the validity test request from the validating system 108. In step 306, the provider system 106 may identify (e.g., via a querying module 214) the computational model the validating system 108 is interested in testing using the supplied identifier and may generate (e.g., via a generation module 216) a synthetic data set that is applicable to the identified computational model using any suitable method, such as a generative adversarial network. As part of the generation of the synthetic data set, the provider system 106 may apply the synthetic data set (e.g., via a modeling module 218) to the identified computational model to generate an expected result value.

In step 308, the provider system 106 may have the synthetic data set posted to a blockchain associated with the blockchain network 104 by transmitting (e.g., via a transmitting device 222) the synthetic data set to a blockchain node 102, which may include the synthetic data set in a blockchain data value that is included in a new block that is generated and confirmed and added to the blockchain using traditional methods and systems. With the synthetic data set being posted to the blockchain, in step 310 the validating system 108 may obtain the synthetic data set by identifying the synthetic data set in a blockchain data value in a block added to the blockchain since the computational model validity test request was submitted in step 302. In some cases, the blockchain data value may also include the identifier associated with the computational model for use in identifying the appropriate synthetic data set.

In step 312, the provider system 106 may transmit (e.g., via a transmitting device 222) the expected result value to the validating system 108 using a suitable communication network and method, where the transmission may be a response to the validity test request submitted by the validating system 108 in step 302 and received by the provider system 106 in step 304. In step 314, the validating system 108 may receive (e.g., via a receiving device 202) the expected result value.

In step 316, the validating system 108 may apply (e.g., via a modeling module 218) the obtained synthetic data set to its own copy of the computational model and obtain a result value. In step 318, the validating system 108 may determine validity of its copy of the computational model by comparing (e.g., by a validation module 220) its obtained result value with the expected result value received from the provider system 106 in step 314. The validating system 108 may then determine how to proceed based on its result of the determination of the validity of the computational model and any other factors, such as if the capabilities and result of the computational model itself are suitable to meet the needs of the validating system 108 or associated entity.

In some embodiments, the process may also include further refinements to the determination of validity of the computational model using additional variables. In such embodiments, the process may further include step 320, where the provider system 106 may transmit (e.g., via a transmitting device 222) additional data variables associated with the provider system 106, computational model, and/or synthetic data set to the validating system 108 using a suitable communication network and method. In some cases, step 320 may be performed before step 316 is performed by the validating system 108. In some instances, step 320 may be performed in response to the receipt of a request for such variables submitted by the validating system 108 (e.g., via a transmitting device 222 thereof). In step 322, the validating system 108 may receive (e.g., via a receiving device 202) the additional data variables from the provider system 106. In step 324, the validating system 108 may refine the results of its determination of the validity of the computational model using the additional data variables. The refinement may be based on the types of additional data variables used. For instance, additional data variables may be used to authenticate the provider system 106, where a failed authentication may negate the determined validity test entirely, or additional data variables may include weighting values that may be used to modify application of the synthetic data set to the computational model to generate different results, which may increase or decrease the validity or accuracy of the computational model.

### Exemplary Method for Determining Validity of a Computational Model

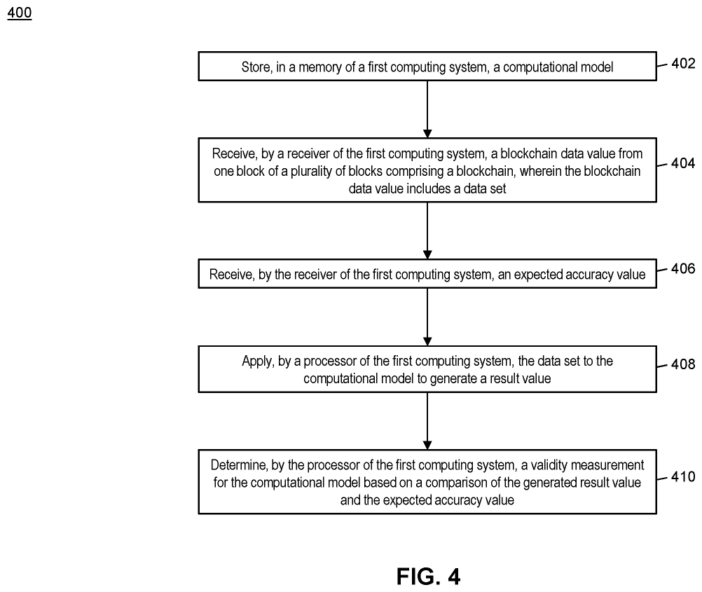

FIG. 4 illustrates a method 400 for determining the validity of a computational model utilizing a blockchain and zero knowledge principles without transmission of the computational model or real data.

In step 402, a computational model may be stored in a memory (e.g., memory 212) of a first computing system (e.g., validating system 108). In step 404, a blockchain data value may be received by a receiver (e.g., receiving device 202) of the first computing system, wherein the blockchain data value is received from one block of a plurality of blocks comprising a blockchain and includes a data set (e.g., a synthetic data set). In step 406, an expected accuracy value may be received by the receiver of the first computing system.

In step 408, the data set may be applied by a processor (e.g., modeling module 218) of the first computing system to the computational model to generate a result value. In step 410, a validity measurement may be determined by the processor (e.g., validation module 220) for the computational model based on a comparison of the generated result value and the expected accuracy value, e.g., the number or percentage of incorrect result events.

In one embodiment, receiving the expected accuracy value may further include receiving a cryptographic key, and the method 400 may further include validating, by the processor (e.g., validation module 220) of the first computing system, the data set using the cryptographic key. In some embodiments, the expected accuracy value may be received from the blockchain data value. In one embodiment, the expected accuracy value may be received from a second computing system (e.g., provider system 106). In a further embodiment, the computational model may be received from the second computing system prior to storage in the memory of the first computing system.

In some embodiments, the method 400 may also include: receiving, by the receiver of the first computing system, one or more additional variables from a second computing system (e.g., the provider system 106); and refining the determined validity measurement based on the one or more additional variables. In one embodiment, the method 400 may further include: generating, by a processor (e.g., generation module 216) of a second computing system (e.g., the provider system 106), the data set; and transmitting, by a transmitter (e.g., transmitting device 222) of the second computing system, the generated data set to a blockchain node (e.g., blockchain node 102) in a blockchain network (e.g., blockchain network 104) for inclusion in the blockchain data value in the one block in the blockchain. In a further embodiment, the data set may be generated using a generative adversarial network.

### Computer System Architecture

FIG. 5 illustrates a computer system 500 in which embodiments of the present disclosure, or portions thereof, may be implemented as computer-readable code. For example, the blockchain node 102, provider system 106, and validating system 108 of FIG. 1 and computing system 200 of FIG. 2 may be implemented in the computer system 500 using hardware, non-transitory computer readable media having instructions stored thereon, or a combination thereof and may be implemented in one or more computer systems or other processing systems. Hardware may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above-described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general-purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software executed on hardware, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for determining the validity of a computational model using a blockchain and zero knowledge principles. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for determining the validity of a computational model using a blockchain and zero knowledge principles, comprising:
storing, in a memory of a first computing system, a computational model;
receiving, by a receiver of the first computing system, a blockchain data value from one block of a plurality of blocks comprising a blockchain, wherein the blockchain data value includes a data set;
receiving, by the receiver of the first computing system, an expected accuracy value;
applying, by a processor of the first computing system, the data set to the computational model to generate a result value; and
determining, by the processor of the first computing system, a validity measurement for the computational model based on a comparison of the generated result value and the expected accuracy value.

2. The method of claim 1, wherein
receiving the expected accuracy value further includes receiving a cryptographic key, and
the method further comprises:
validating, by the processor of the first computing system, the data set using the cryptographic key.

3. The method of claim 1, wherein the expected accuracy value is received from the blockchain data value.

4. The method of claim 1, wherein the expected accuracy value is received from a second computing system.

5. The method of claim 4, wherein the computational model is received from the second computing system prior to storage in the memory of the first computing system.

6. The method of claim 1, further comprising:
receiving, by the receiver of the first computing system, one or more additional variables from a second computing system; and
refining the determined validity measurement based on the one or more additional variables.

7. The method of claim 1, further comprising:
generating, by a processor of a second computing system, the data set; and
transmitting, by a transmitter of the second computing system, the generated data set to a blockchain node in a blockchain network for inclusion in the blockchain data value in the one block in the blockchain.

8. The method of claim 7, wherein the data set is generated using a generative adversarial network.

9. A system for determining the validity of a computational model using a blockchain and zero knowledge principles, comprising:
a first computing system including
a memory storing a computational model,
a receiver receiving
a blockchain data value from one block of a plurality of blocks comprising a blockchain, wherein the blockchain data value includes a data set, and
an expected accuracy value, and
a processor
applying the data set to the computational model to generate a result value, and
determining a validity measurement for the computational model based on a comparison of the generated result value and the expected accuracy value.

10. The system of claim 9, wherein
receiving the expected accuracy value further includes receiving a cryptographic key, and
the processor of the first computing system further validates the data set using the cryptographic key.

11. The system of claim 9, wherein the expected accuracy value is received from the blockchain data value.

12. The system of claim 1, further comprising:
a second computing system, wherein
the expected accuracy value is received from a second computing system.

13. The system of claim 12, wherein the computational model is received from the second computing system prior to storage in the memory of the first computing system.

14. The system of claim 9, further comprising:
a second computing system, wherein
the receiver of the first computing system receives one or more additional variables from a second computing system, and
the processor of the first computing system refines the determined validity measurement based on the one or more additional variables.

15. The system of claim 9, further comprising:
a blockchain node in a blockchain network; and
a second computing system including
a processor generating the data set, and
a transmitter transmitting the generated data set to the blockchain node for inclusion in the blockchain data value in the one block in the blockchain.

16. The system of claim 15, wherein the data set is generated using a generative adversarial network.
